(19) United States
(12) Patent Application Publication
(10) Pub. No.: US 2020/0300105 A1
(43) Pub. Date: Sep. 24, 2020

(54) GAS TURBINE ENGINE, CORRESPONDING SEAL SECTION AND INTEGRATED EXIT PIECE

(71) Applicant: Siemens Aktiengesellschaft, München (DE)

(72) Inventors: Jacob William Hardes, Charlotte, NC (US); Manish Kumar, Charlotte, NC (US); Adam J. Weaver, Oviedo, FL (US)

(21) Appl. No.: 16/088,204

(22) PCT Filed: Mar. 25, 2016
(86) PCT No.: PCT/US2016/024142

§ 371 Date: Sep. 25, 2018

(51) Int. Cl. F01D 11/00; F01D 9/02; F02C 7/28

(52) U.S. Cl. CPC F01D 11/005; F01D 9/023; F02C 7/28; F05D 2260/30; F23R 2900/00012; F05D 2240/12; F05D 2240/35; F05D 2240/55; F05D 2230/60; F05D 2250/75

(57) ABSTRACT

A gas turbine engine has an outer ring (15) formed by integrated exit pieces (10) and surrounds an inner ring (16). A seal section (20) having an L-shaped cross-section is connected to and seals the outer ring (15) and the inner ring (16).

### BACKGROUND

### 1. Field

Disclosed embodiments are generally related to gas turbine engines and, more particularly to the transition system of a gas turbine engine.

### 2. Description of the Related Art

Gas turbine engines with can annular combustors have transition ducts to conduct and direct the gasses from the combustors to rows of turbine blades. The transition ducts as well as vanes orient the combustion gas flow streams to contact the turbine blades at preferred angles for rotation of the blades.

In some gas turbine engines, the transition ducts are arranged in an annular array. The annular array is formed around an inner ring that provides support. Effective sealing between the annular array and the inner ring is desired.

### SUMMARY

Briefly described, aspects of the present disclosure relate to seals used in gas turbine engines.

An aspect of the disclosure may be a gas turbine engine having a plurality of integrated exit pieces arranged to form an outer ring, wherein each of the plurality of integrated exit pieces has a first slot formed therein; an inner ring located radially inwards with respect to the plurality of integrated exit pieces, wherein the inner ring has a second slot formed therein. The gas turbine engine may also have a seal section having a first extending portion and a second extending portion, wherein the first extending portion is located in the first slot and the second extending portion is located in the second slot, wherein the first extending portion extends in an axial direction with respect to the outer ring and the second extending portion extends radially inwards with respect to the outer ring, wherein both the first extending portion and the second extending portion extend circumferentially within the first slot and the second slot.

Another aspect of the disclosure may be a seal section for use in a gas turbine engine. The seal section may have a first extending portion, wherein the first extending portion is located within a first slot, wherein the first slot is formed within one of a plurality of integrated exit pieces, wherein the plurality of integrated exit pieces form an outer ring; a second extending portion located in a second slot formed in an inner ring, wherein the inner ring is located radially inwards with respect to the outer ring; and wherein the first extending portion extends in an axial direction with respect to the outer ring and the second extending portion extends radially inwards with respect to the outer ring, wherein both the first extending portion and the second extending portion extend circumferentially within the first slot and the second slot.

Still another aspect of the disclosure may be an integrated exit piece forming an outer ring in a gas turbine engine having a first slot, wherein the first slot is adapted to receive a seal section for use in a gas turbine engine, wherein the seal section comprises a first extending portion adapted to be located within the first slot, a second extending portion adapted to be located in a second slot formed in an inner ring, wherein the inner ring is located radially inwards with respect to the outer ring; and wherein the first extending portion extends in an axial direction with respect to the outer ring and the second extending portion extends radially inwards with respect to the outer ring, wherein both the first extending portion and the second extending portion extend circumferentially within the first slot and the second slot.

### BRIEF DESCRIPTION OF THE DRAWINGS

FIG. 1 shows an integrated exit piece.

FIG. 2 shows the integrated exit piece forming an outer ring.

FIG. 3 shows an integrated exit piece forming an outer ring connected to an inner ring.

FIG. 4 is a view of a first layer of the seal section connected to the integrated exit piece and the inner ring.

FIG. 5 is a view of a second layer of the seal section connected to the integrated exit piece and the inner ring.

FIG. 6 is a close up view of the anti-rotation structure used with the seal section.

FIG. 7 is a view of the first layer of the seal section and the second layer of the seal section showing ship lapping of the first layer and second layer.

FIG. 8 is a view of the seal section connecting the inner ring and the outer ring.

FIG. 9 is a view of the seal section connecting the inner ring and the outer ring with a view of the slots located in the outer ring and the inner ring.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

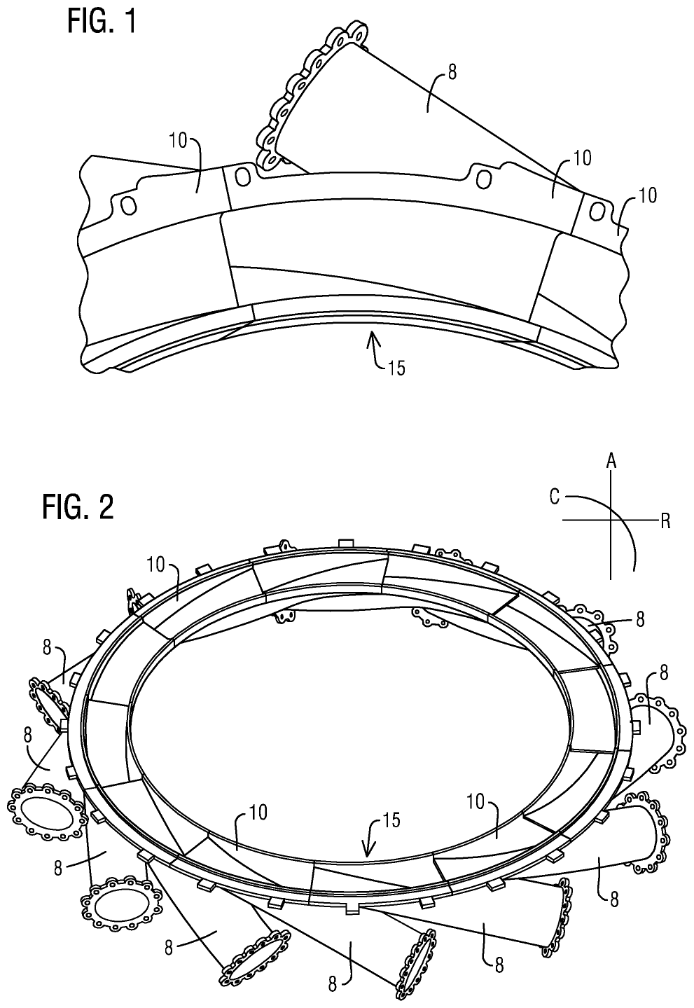

FIG. 1 shows an integrated exit piece (IEP) 10 that is used in gas turbine engines. The IEP 10 is connected to a transition duct 8 that transports the gasses from the combustors to rows of turbine blades. Transition ducts as well as vanes orient the combustion gas flow streams to contact the turbine blades at preferred angles for rotation of the blades. FIG. 2 shows the outer ring 15 that is formed by the connection of more than one IEP 10 to each other. The IEPs 10 are adjacently connected along the circumferential direction C.

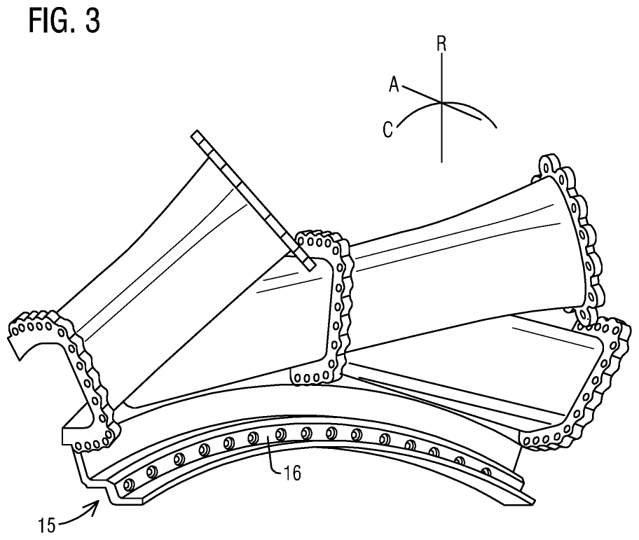

FIG. 3 shows a partial view the IEPs 10 forming an outer ring 15 connected to an inner ring 16. The outer ring 15 is located further outwards in the radial direction R than the inner ring 16 from an axis running through the center of the outer ring 15 and the inner ring 16.

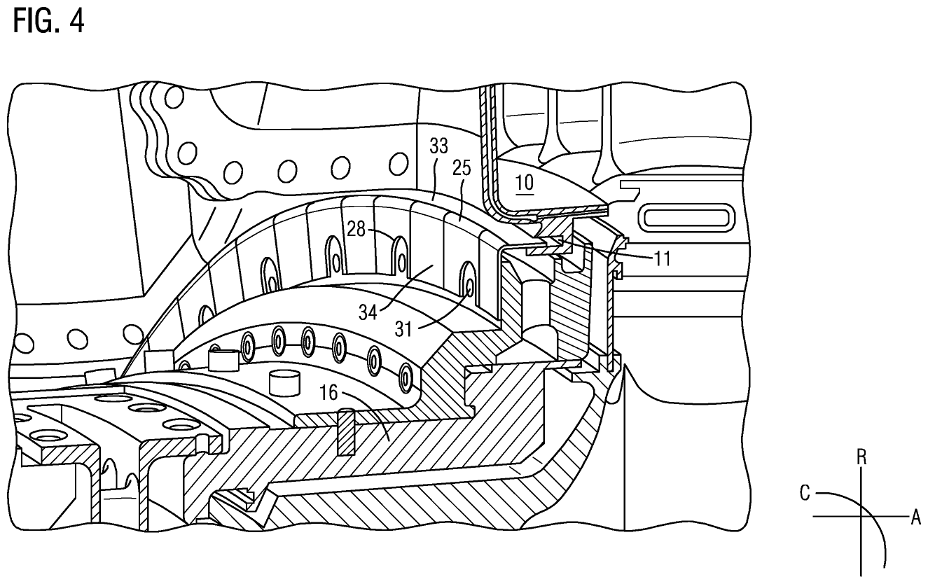

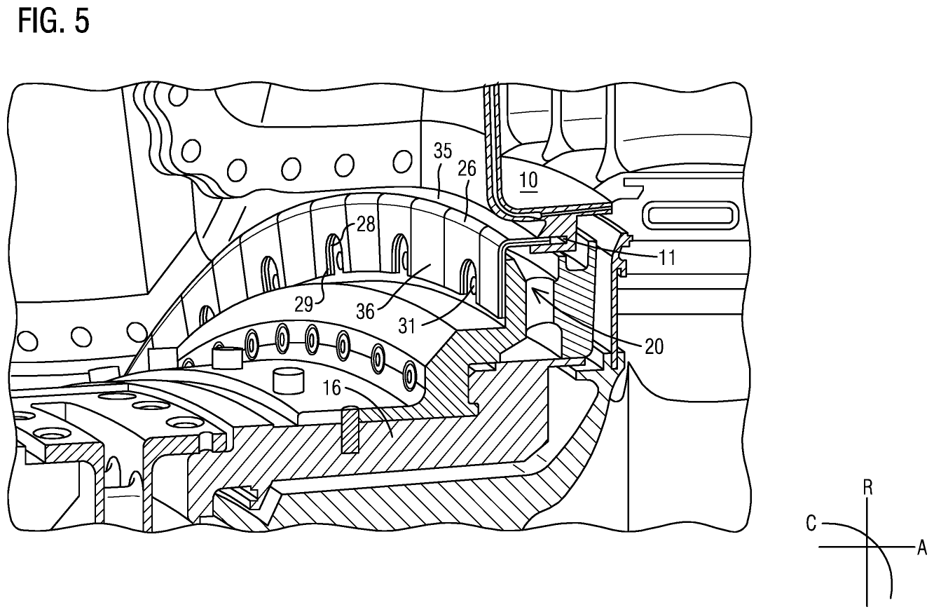

FIG. 4 is a view of a first layer 25 of the seal section 20, shown in FIG. 5, that is connected to the IEP 10 and the inner ring 16. The first layer 25 is shown inserted into a first slot 11 that is located within the IEP 10. The first layer 25 has a first layer axial section 33 that extends in an axial direction A into the first slot 11. Connected to the first layer axial section 33 and also forming part of the first layer 25 is a first layer radial section 34 that extends in the radial direction R. The first layer 25 is arced shaped and conforms to the shape of the inner ring 16 and outer ring 15.

First layer 25 extends in a circumferential direction C and has first layer cut outs 28 formed in the first layer radial section 34. The first layer cut outs 28 are preferably arched shaped so as to accommodate movement of the first layer 25 during operation of the gas turbine engine. In FIG. 4 the first layer cut outs 28 are spaced equidistantly from each other. However it should be understood that other configurations of the first layer cut outs 28 may be arranged in the first layer radial section 34. The first layer cut outs 28 further prevent the movement of the first layer 25 in the circumferential direction C when the seal section 20 is fully assembled.

First layer 25 forms an arc that extends in the circumferential direction C. The individual first layers 25 may form arcs of between 7.5° to 30° and may vary in number depending on the number of IEPs 10. Preferably each of the first layers 25 used to form a seal section 20 have the same arc. The arcs of the first layers 25 preferably sum to 360° in order to completely seal the space between the outer ring 15 and the inner ring 16.

FIG. 5 is a view of the second layer 26 of the seal section 20 connected to the IEP 10 and the inner ring 16. The second layer 26 is shown inserted into a first slot 11 that is located within the IEP 10. The second layer 26 is arced shaped and conforms to the shape of the inner ring 16 and outer ring 15, as well as to the shape of the first layer 25. The second layer 26 has a second layer axial section 35 that extends in the axial direction A into the first slot 11. Connected to the second layer axial section 35 and also forming part of the second layer 26 is a second layer radial section 36 that extends in the radial direction R.

Second layer 26 extends in the circumferential direction C and has second layer cut outs 29 formed in the second layer radial section 36. Second layer cut outs 29 are preferably arch shaped and also correspond to the shape of the first layer cut outs 28. In FIG. 5 the second layer cut outs 29 are spaced equidistantly from each other. However it should be understood that other configurations of the second layer cut outs 29 may be arranged in the second layer radial section 36. The second layer cut outs 29 are positioned within the second layer 26 so that they correspond to the location of the first layer cut outs 28 located within the first layer 25 when the second layer 26 is positioned on the first layer 25.

Second layer 26 forms an arc that extends in the circumferential direction C. The individual second layers 26 may form arcs of between 7.5° to 30° and may vary in number depending on the number of IEPs 10. Preferably each of the second layers 26 used to form a seal section 20 have the same arc. The arcs of the second layer 26 preferably sum to 360° in order to completely seal the space between the outer ring 15 and the inner ring 16. In one embodiment first layer 25 and second layer 26 each forms an arc that is 14.75°.

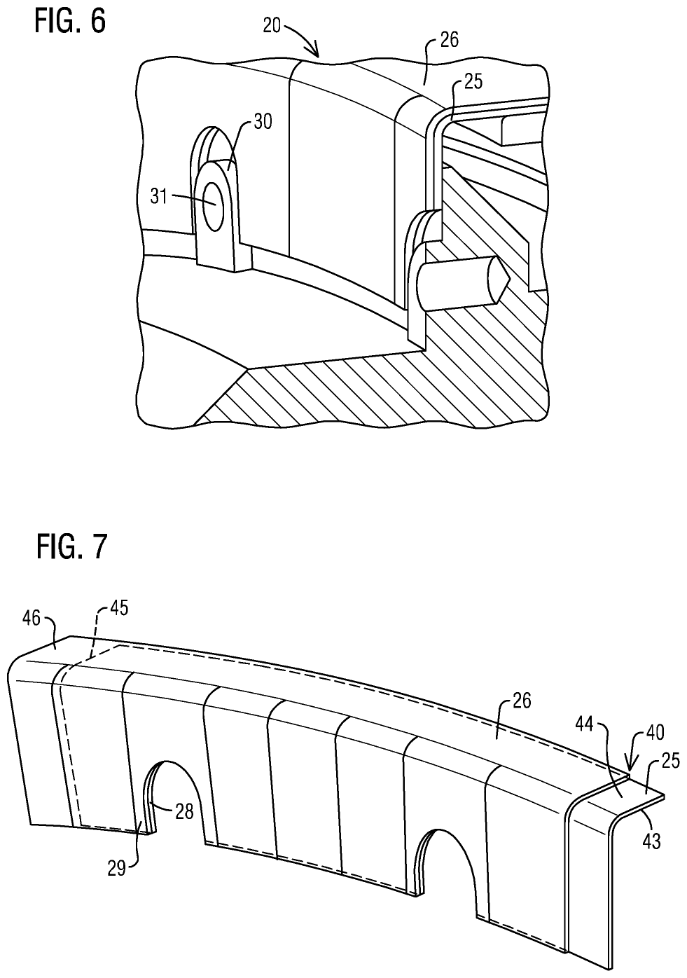

FIG. 6 is a close up view of the anti-rotation structure 30 used with the seal section 20. The anti rotation structure 30 is located on the inner ring 16. When the first layer 25 and the second layer 26 are assembled, the first layer cut out 28 of the first layer 25 and the second layer cut out 29 of the second layer 26 align with each other. The aligned first layer cut out 28 and second layer cut out 29 are positioned over the anti rotation structure 30. As shown, the anti-rotation structure 30 is arched shaped and corresponding to the shapes of the first layer cut out 28 and the second layer cut out 29. Located within the anti-rotation structure 30 are bolt holes 31.

FIG. 7 is a view of the first layer 25 and the second layer 26 of the seal section 20 showing the shiplap 40 of the first layer 25 and second layer 26. The shiplap 40 is the interface between the first layer 25 and the second layer 26 where the second layer 26 begins to overlap the first layer 25. As shown the second layer edge 44 does not extend as far circumferentially as the first layer edge 43. At opposite ends of the first layer 25 and the second layer 26, the second layer edge 46 extends further than the first layer edge 45. The shiplap 40 permits more secure mating of the first layer 25 and the second layer 26 as it extends around the circumference of the outer ring 15 and inner ring 16. While the first layer edges 43, 45 do not align with the second layer edges 44, 46 the first layer cut outs 28 and the second layer cut outs 29 do align so as to surround anti-rotation structures 30. When the first layer 25 and the second layer 26 are shiplapped the first layer 25 and the second layer 26 each forms an arc that is 14.75°. Together the seal section 20 formed by the first layer 25 and the second layer 26 form an arc of 15.75°. The overlapping of the second layer 26 of the first layer 25 may be 0.75°.

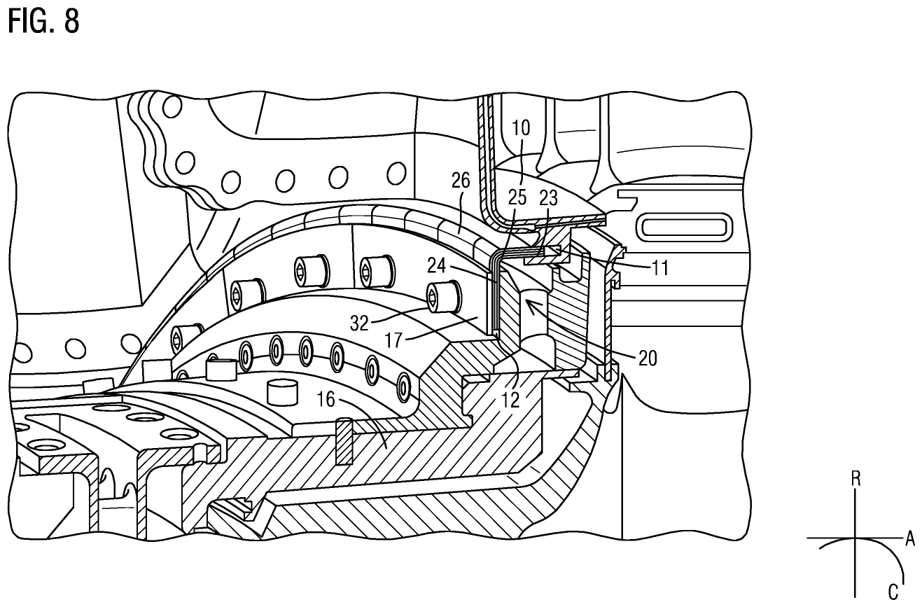

FIG. 8 is a view of the first layer 25 and the second layer 26 fully assembled and forming the seal section 20. Upon installing the seal section 20 between the outer ring 15 and the inner ring 16, a retention plate 17 is secured to the anti-rotation structures 30 using bolts 32 placed through the bolt holes 31. It should be understood that retention plate 30 may be secured to the anti-rotation structures 30 via other suitable methods, such as brazing or welding.

The seal section 20 has a first extending portion 23 formed by the first layer axial section 33 and the second layer axial section 35. The first extending portion 23 extends in the axial direction A into the first slot 11. Securing the retention plate 17 forms a second slot 12. The second slot 12 receives the second extending portion 24 of the seal section 20 which extends in the radial direction R into the second slot 12. The second extending portion 24 is formed by the first layer radial section 34 and second layer radial section 36.

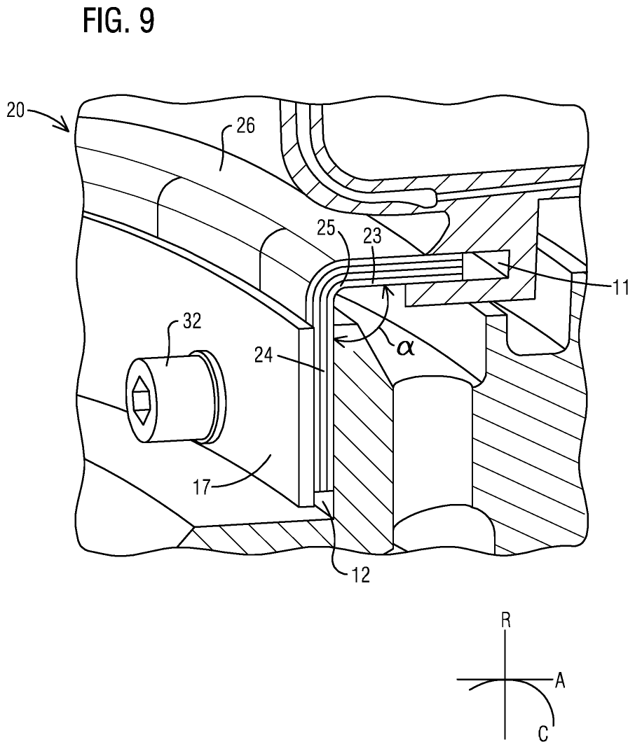

As shown in FIG. 8, the first extending portion 23 and the second extending portion 24 form an L-shaped cross section. Referring to FIG. 9, while the L-shaped cross-section is L-shaped it should be understood that the angle α formed at the location where the first extending portion 23 and the second extending portion 24 meet, it is not necessarily 90°. Instead the angle α may be within a range of 80° to 100° in order to accommodate the curvature of the seal section 20. Further, other configurations other than L-shaped are possible, for example a C-shape, V-shaped, or obtuse angle shape may also be formed.

FIG. 9 also shows a view of the seal section 20 connecting the inner ring 16 and the outer ring 15 with a close-up view of the first slot 11 and second slot 12 located in the outer ring 15 and the inner ring 16.

FIG. 9 illustrates that the first extending portion 23 does not extend fully into the first slot 11. There is still space in the axial direction A in which the first extending portion 23 may move axially. The range in which the first extending portion 23 may move is sufficient to accommodate the stresses and deformations that may occur during the operation of the gas turbine engine. The deformations and stresses can be accommodated while the seal section 20 continues to seal the space between the outer ring 15 and inner ring 16. Additionally the first slot 11 has sufficient space to permit the first extending portion 23 to move in the radial direction R in order to accommodate stresses and deformations that may occur during the operation of the gas turbine engine.

FIG. 9 also shows that the second extending portion 24 does not extend fully into the second slot 12. There is still space in the radial direction R in which the second extending portion 24 may move radially. The range in which the second extending portion 24 may move is sufficient to accommodate the stresses and deformations that may occur during the operation of the gas turbine engine. The deformations and stresses can be accommodated while the seal section 20 continues to seal the space between the outer ring 15 and inner ring 16. Additionally the second slot 12 has sufficient space to permit the second extending portion 24 to move in the axial direction A in order to accommodate stresses and deformations that may occur during the operation of the gas turbine engine.

Additionally, the ability for each seal section 20 to move in the radial direction R and the axial direction A permits each seal section 20 to be able to move with respect to each other. This permits greater flexibility for the stresses and deformations to be compensated for without jeopardizing the integrity of the seal section 20.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

1. A gas turbine engine comprising:
a plurality of integrated exit pieces arranged to form an outer ring, wherein each of the plurality of integrated exit pieces has a first slot formed therein;
an inner ring located radially inwards with respect to the plurality of integrated exit pieces, wherein the inner ring has a second slot formed therein; and
a seal section having a first extending portion and a second extending portion, (24), wherein the first extending portion is located in the first slot and the second extending portion is located in the second slot, wherein the first extending portion extends in an axial direction with respect to the outer ring and the second extending portion extends radially inwards with respect to the outer ring, wherein both the first extending portion and the second extending portion extend circumferentially within the first slot and the second slot.

2. The gas turbine engine of claim 1, wherein a cross section of the seal section in a radial direction is L shaped.

3. The gas turbine engine of claim 1, wherein the seal section has a first layer and a second layer, wherein the first layer has a first edge and the second layer has a second edge, wherein the first edge of the first layer extends circumferentially further than the second edge of the second layer.

4. The gas turbine engine of claim 3, wherein the first layer and the second layer are shiplapped in a circumferential direction.

5. The gas turbine engine of claim 1, wherein arch shaped cutouts are formed in the second extending portion of the seal section.

6. The gas turbine engine of claim 5, wherein an anti-rotation structure extends from the inner ring and into the arch shaped cutouts formed in the second extending portion of the seal section, wherein the anti-rotation structure is arched shaped and prevents rotation in the circumferential direction by the seal section.

7. The gas turbine engine of claim 1, wherein the first extending portion can move in axially and radially within the first slot.

8. The gas turbine engine of claim 7, wherein the second extending portion can move radially and axially within the second slot.

9. The gas turbine engine of claim 1, wherein the inner ring comprises a retention plate extending circumferentially, wherein the retention plate forms the second slot.

10. The gas turbine engine of claim 1, wherein the seal section is one of a plurality of seal sections extending circumferentially around the outer ring and the inner ring, wherein each of the plurality of seal sections forms an arc between 7.5° to 30°.

11. A seal section for use in a gas turbine engine comprising:
a first extending portion, wherein the first extending portion is located within a first slot, wherein the first slot is formed within one of a plurality of integrated exit pieces, wherein the plurality of integrated exit pieces form an outer ring;
a second extending portion located in a second slot formed in an inner ring, wherein the inner ring is located radially inwards with respect to the outer ring; and
wherein the first extending portion extends in an axial direction with respect to the outer ring and the second extending portion extends radially inwards with respect to the outer ring, wherein both the first extending portion and the second extending portion extend circumferentially within the first slot and the second slot.

12. The seal section of claim 11, wherein a cross section of the seal section in a radial direction is L shaped.

13. The seal section of claim 11, wherein the seal section has a first layer and a second layer, wherein the first layer has a first edge and the second layer has a second edge, wherein the first edge of the first layer extends circumferentially further than the second edge of the second layer.

14. The seal section of claim 13, wherein the first layer and the second layer are shiplapped in a circumferential direction.

15. The seal section of claim 11, wherein arch shaped cutouts are formed in the second extending portion of the seal section.

16. The seal section of claim 15, wherein an anti-rotation structure extends from the inner ring and into the arch shaped cutouts formed in the second extending portion of the seal section, wherein the anti-rotation structure is arched shaped and prevents rotation in the circumferential direction by the seal section.

17. The seal section of claim 11, wherein the first extending portion is sized to move axially and radially within the first slot.

18. The seal section of claim 17, wherein the second extending portion is sized to move radially and axially within the second slot.

19. The seal section of claim 11, wherein the seal section forms an arc between 7.5° to 30°.

20. An integrated exit piece forming an outer ring in a gas turbine engine comprising:
a first slot, wherein the first slot is adapted to receive a seal section for use in a gas turbine engine, wherein the seal section comprises a first extending portion adapted to be located within the first slot, a second extending portion adapted to be located in a second slot formed in an inner ring, wherein the inner ring is located radially inwards with respect to the outer ring;
and wherein the first extending portion extends in an axial direction with respect to the outer ring and the second extending portion extends radially inwards with respect to the outer ring, wherein both the first extending portion and the second extending portion extend circumferentially within the first slot and the second slot.
